(19) United States
(12) Patent Application Publication
(10) Pub. No.: US 2008/0130720 A1
(43) Pub. Date: Jun. 5, 2008

(54) RECEIVER PROCESSING SYSTEM

(75) Inventor: Anthony Craig Dolwin, Bristol (GB)

Correspondence Address: OBLON, SPIVAK, MCCLELLAND MAIER & NEUSTADT, P.C., 1940 DUKE STREET, ALEXANDRIA, VA, 22314, US

(73) Assignee: Kabushiki Kaisha Toshiba, Tokyo (JP)

(21) Appl. No.: 11/946,739

(22) Filed: Nov. 28, 2007

Related U.S. Application Data
(62) Division of application No. 10/285,638, filed on Nov. 1, 2002.

(30) Foreign Application Priority Data
Nov. 2, 2001 (GB) 0126381.3

(51) Int. Cl. H04B 1/707

(52) U.S. Cl. 375/149; 375/150; 375/E01.002

(57) ABSTRACT

A method of adjusting the relative timing of a spreading sequence and a sampled input signal for a spread spectrum receiver correlator, the spreading sequence having an associated spreading sequence chip clock, the input signal being sampled at sample clock intervals, the method comprising: delaying the sampled input signal by an integral number of sample clock intervals to provide a fine relative timing adjustment; and delaying the spreading sequence by an integral number of spreading sequence chip clock periods to provide a coarse relative timing adjustment.

### FIELD OF THE INVENTION

This invention relates to spread spectrum receivers, in particular rake receivers. It has applications in 3G mobile phone systems.

### BACKGROUND TO THE INVENTION

Third generation mobile phone networks use CDMA (Code Division Multiple Access) spread spectrum signals for communicating across the radio interface between a mobile station and a base station. A 3G network is known as a UMTS (Universal Mobile Telecommunications System) network and UMTS is the subject of standards produced by the Third Generation Partnership Project (3GPP, 3GPP2). Technical specifications for 3GPP and 3PGG2 can be found at www.3gpp.org. and are hereby incorporated by reference.

In a CDMA spread spectrum communication system a baseband signal is spread by mixing it with a pseudorandom spreading sequence of a much higher bit rate (referred to as the chip rate) before modulating the rf carrier. At the receiver the baseband signal is recovered by feeding the received signal and the pseudorandom spreading sequence into a correlator and allowing one to slip past the other until a lock is obtained. Once code lock has been obtained, it is maintained by means of a code tracking loop such as an early-late tracking loop which detects when the input signal is early or late with respect to the spreading sequence and compensates for the change.

Such a system is described as code division multiplexed as the baseband signal can only be recovered if the initial pseudorandom spreading sequence is known. A spread spectrum communication system allows many transmitters with different spreading sequences all to use the same part of the rf spectrum, a receiver “tuning” to the desired signal by selecting the appropriate spreading sequence.

One example of a spread spectrum mobile phone system, Interim Standard 95 (IS-95) has 64 orthogonal spreading sequences generated by Walsh functions. Theoretically this allows up to 64 simultaneous users of a given portion of spectrum but this is not necessarily sufficient, particularly because of the possibility of interference between users in different cells of the mobile phone network. The baseband signals are therefore further scrambled using a second pseudorandom sequence, known as a scramble code, which is combined with the spreading sequence.

One advantage of spread spectrum systems is that they are relatively insensitive to multipath fading. Multipath fading arises when a signal from a transmitter to a receiver takes two or more different paths and hence two or more versions of signal arrive at the receiver at different times and interfere with one another. This typically produces a comb-like frequency response which can change with time when the receiver or transmitter is moving. A spread spectrum signal occupies a relatively wide band and is therefore less affected by the nulls of the comb. Furthermore, because of the way the receiver works it will lock onto only one of the multipath components, normally the direct signal which is the strongest. It will be appreciated, however, that with additional correlators a receiver could lock separately onto each multipath component and combine the results to provide an improved signal to noise ratio for bit error rate. A rake receiver performs this function.

FIG. 1 shows the main components of a typical rake receiver 10. A band of correlators 12 comprises, in this example, three correlators 12a, 12b and 12c each of which receives a CDMA signal from input 14. The correlators are known as the fingers of the rake; in the illustrated example the rake has three fingers. The CDMA signal may be at baseband or at IF (Intermediate Frequency). Each correlator locks to a separate multipath component which is delayed by at least one chip with respect to the other multipath components. More or fewer correlators can be provided according to a quality-cost/complexity trade off. The outputs of all the correlators go to a combiner 16 which adds the outputs in a weighted sum, generally giving greater weight to the stronger signals. The weighting may be determined based upon signal strength before or after correlation, according to conventional algorithms. The combined signal is then fed to a discriminator 18 which makes a decision as to whether a bit is a 1 or a 0 and provides a baseband output. The discriminator may include additional filtering, integration or other processing. The rake receiver 10 may be implemented in either hardware or software or a mixture of both.

In a conventional rake receiver the configuration of the functional blocks is fixed to support a predetermined wireless system and rake finger algorithm, for example early-late code tracking. This has a number of disadvantages, in the main arising because such a fixed design will generally only be suitable for use with one particular wireless system configuration. Even then it may make inefficient use of the receiver hardware as some functions, such as tracking correlators, can be redundant under some operational conditions. The 3GPP and 3GPP2 specifications, however, allow for a very large number of operational configurations with many different data rates and physical channels. The early designs for aspects of this 3G system have chosen to implement a subset of these requirements to minimise design complexity and significant redesign is required if the full set of requirements is to be supported. Were the conventional approach to rake receiver design to be adopted the overall complexity would be very great as the system would need to be able to accommodate the extremes of the requirement specification, such as a large number of multirate channels in good channel conditions and low data rates in very bad channel conditions.

U.S. Pat. No. 6,259,720 describes a digital signal processing system architecture for implementing signal processing functions such as filtering, spreading, de-spreading, rake filtering and equalisation. Eight separate cascaded processing blocks, each having a de-spread, filter, and decimate function are provided so that the DSP system can be used to provide either one large filter or combinations of filtering. The architecture described in this patent is efficient for implementing filtering and related operations but there still exists a need for a more general, flexible rake architecture. U.S. Pat. No. 5,365,549 describes a complex signal correlator, that is a correlator with real and imaginary (I and Q) components in which multipliers are replaced by adders by employing a relative rotation of the signals to be correlated.

In view of these conventional designs there is a need for a flexible architecture for a multi-standard rake receiver to support a desirable range of requirements set out in the 3GPP and 3GPP2 specifications.

### SUMMARY OF THE INVENTION

In a first aspect the present invention therefore provides a correlator for a spread spectrum receiver, the correlator comprising, a spread spectrum input, a first programmable sequence generator having a first spreading sequence output, a second programmable spreading sequence generator having a second spreading sequence output, and a multiplexer having first and second inputs coupled to said first and second spreading sequence generator outputs and having an output, to selectively provide one of said first and second spreading sequences to said output; and a correlator module having a first input coupled to the spread spectrum input and a second input coupled to the multiplexer output, and having an output to provide a correlation result.

By providing two (or more) programmable spreading sequence generators which can be selectively coupled to the correlator module the correlator can be programmed to perform two or more separate casks by reallocation of the correlator module resource. The configuration also allows the correlator to be time multiplexed either to perform partial correlation calculations for a single result, such as real and imaginary correlations, or to perform separate correlation calculations to identify separate signals or signal components. The correlator can thus be used to support multiple wireless systems and/or multiple algorithms and adaptive algorithms. It also allows a manufacturer to modify a receiver design after the hardware has been embodied in silicon, and can therefore provide a software-defined radio. For example if the correlator is incorporated into a rake receiver the receiver can be arranged to vary the number of rake fingers according to the goodness of channel reception. A further advantage provided by the correlator is the scalability of its architecture. The components of the correlator may be implemented in either hardware or software or both.

The invention also provides a method of providing a plurality logical correlators using a correlator comprising a single correlator module, the method comprising providing a plurality of programmable spreading sequence generators for said plurality of logical correlators, providing a spread spectrum input signal to the single correlator module, programming said correlator to selectively couple one of said spreading sequence generators to said single correlator module to provide a first said logical correlator, performing a correlation operation using said first logical correlator; and repeating the programming and performing a correlation steps to provide one or more further logical correlators.

The logical correlators may be provided to reconfigure a receiver such as a rake receiver or to provide a plurality of time-multiplexed partial correlations, or to provide time multiplexed correlation operations to provide a plurality of separate logical correlators, for example for different fingers of a rake receiver.

In another aspect the invention provides a spread spectrum receiver including a processor, program memory coupled to the processor, and a time-multiplexable correlator, the correlator comprising a spread spectrum input, a spreading sequence input, a correlator module having a first input coupled to said spectrum input and a second input coupled to said spreading sequence input, and having an output to provide a correlation result, and at least one control register for configuring a mode of operation of the correlator, the program memory storing processor implementable instructions for controlling the processor to write a plurality of values to the at least one control register to configure the correlator to provide a corresponding plurality of time multiplexed logical correlation operations.

The correlator module may be configured to perform different correlation operations by writing different values in turn to the at least one control register, or a set of values specifying the correlator configurations may be written in an initiation step and the correlator may then automatically cycle through the different configurations.

In a related aspect the invention also provides a method of implementing a spread spectrum receiver comprising multiple correlators, the method comprising, providing a programmable correlator including at least one control register for configuring a mode of operation of the correlator, writing data to said at least one control register, said data comprising data to configure the programmable correlator to provide a plurality of logical correlators; and time multiplexing said programmable correlator to provide said plurality of logical correlators for said multiple correlators.

The invention further provides a spread spectrum receiver architecture comprising an input signal sampler to provide a sampled input signal, input signal delay means coupled to said input signal sampler to provide a set of delayed sampled signals having different relative delays, a spreading sequence generator to provide a spreading sequence signal, spreading sequence delay means coupled to said spreading sequence generator to provide a set of delayed spreading sequence signals having different relative delays, a correlator having first and second inputs and an output dependent upon the correlation between signals received at the first and second inputs, first selection means coupled to the input signal delay means and to the first input of the correlator for selectively providing one of said set of delayed sampled signals to the correlator, second selection means coupled to the spreading sequence delay means and to the second input of the correlator for selectively providing one of said set of delayed spreading sequence signals to the correlator, whereby the relative timing of said sampled input signal and said spreading sequence signal at said correlator can be adjusted.

The invention also provides a spread spectrum receiver subsystem comprising an input signal sampler to provide a sampled input signal, input signal delay means coupled to said input signal sampler to provide a set of delayed sampled signals having different relative delays, a spreading sequence generator to provide a spreading sequence signal, spreading sequence delay means coupled to said spreading sequence generator to provide a set of delayed spreading sequence signals having different relative delays, a correlator having first and second inputs and an output dependent upon the correlation between signals received at the first and second inputs, first selection means coupled to the input signal delay means and to the first input of the correlator for selectively providing one of said set of delayed sampled signals to the correlator, second selection means coupled to the spreading sequence delay means and to the second input of the correlator for selectively providing one of said set of delayed spreading sequence signals to the correlator, whereby the relative timing of said sampled input signal and said spreading sequence signal at said correlator can be adjusted.

Generally the input signal is sampled at a sampling frequency which is higher than the spreading chip clock frequency so that fine timing changes may be made by selecting the delayed input signal and larger changes in timing may be made by selecting the delayed spreading sequence signal. Preferably the subsytem also incorporates a scramble code generator which can be restarted to allow still larger timing changes.

The invention also provides a corresponding method of adjusting the relative timing of a spreading sequence and a sampled input signal for a spread spectrum receiver correlator, the spreading sequence having an associated spreading sequence chip clock, the input signal being sampled at sample clock intervals, the method comprising, delaying the sampled input signal by an integral number of sample clock intervals to provide a fine relative timing adjustment, and delaying the spreading sequence by an integral number of spreading sequence chip clock periods to provide a coarse relative timing adjustment.

In a related aspect the invention provides a method of adjusting the relative timing of a spreading sequence and a sampled input signal for a spread spectrum receiver correlator, wherein the spreading sequence comprises a combination of a first pseudorandom sequence and a second pseudorandom sequence equal to or longer than the first sequence, the method comprising adjusting said relative timing by restarting the second pseudorandom sequence.

In an embodiment of this method the second pseudorandom sequence comprises a scramble code sequence. The timing between the pseudorandom sequences (scramble sequence and spreading sequence) has to be synchronised and thus the timing of the restarting of each has to be substantially identical. This is achieved by having two timing control blocks, one associated with a scramble code generator and the other associated with a PN sequence block. In an alternative embodiment a single timing control block supplies control signals to both pseudorandom sequence generators.

### BRIEF DESCRIPTION OF THE DRAWINGS

These and other aspects of the invention will now be further described, by way of example only, with reference to the accompanying figures in which:

FIGS. 1a and 1b show, respectively, a typical rake receiver and a typical rf front end for a spread spectrum receiver;

FIG. 2 shows a block diagram of a rake receiver system according to an embodiment of the present invention;

FIG. 3 shows functional elements of a correlator embodying an aspect of the present invention; and

FIG. 4 shows an implementation of a correlator embodying an aspect of the present invention.

### DETAILED DESCRIPTION OF PREFERRED EMBODIMENTS

A rake receiver according to an embodiment of the present invention comprises one or more scramble code generators, one or more PN (pseudonoise) blocks, one or more partial complex correlators, one or more combiner modules, and a single discriminator allocation and configuration module. The receiver also includes a processor coupled to programme and data memory for setting up and controlling the receiver.

Each scramble code generator is capable of producing a complex (i.e. real and imaginary) binary PN sequence. The controlling processor can configure the precise timing and value of this sequence dynamically. Each PN block can select one of the scramble code generators as its input. The PN block also generates a binary spreading sequence derived from a row in a Walsh matrix. The (real) spreading sequence and the complex scramble code sequence are then combined to form a complex output sequence, which is here referred to as a combined PN sequence. The method of combining these sequences is determined by configuration data written by the processor to the PN block. In a wideband CDMA (WCDMA) 3G system a complex multiplication is used; in a CDMA 2000 System the method of combining the sequences is more complex as a pseudorandom element must be included. The methods of combining the sequences are conventional and known to those skilled in the art; the processor is able to select the method of combining by appropriately configuring the PN block.

Each of the one or more partial complex correlators calculates the cross correlation between two complex sequences. In embodiments of the receiver the correlator operates on both real and imaginary inputs from the two complex sequences to generate either a real or imaginary output. The correlator is therefore referred to as “partial” because it only generates half of the complex correlation at any one time. A transformation (rotation) of one or other (or both) of the input sequences is employed before the cross correlation calculation to achieve this. Thus a further aspect of the invention provides a partial correlator comprising a complex rotation module coupled to one input of a cross correlation calculator.

One of the sequences input to one of these partial complex correlators comprises a combined PN sequence having binary values whilst the other input comprises a sampled IQ signal from an rf receiver front end. The output from the correlator can be chosen by the processor to be either the real or imaginary component of the correlation result. The source of the combined PN sequence input to the partial complex correlator can be selected from one of a plurality of PN blocks. The correlator also has the ability to delay the combined PN sequence by integral multiples of the chip period, under control of the processor. Likewise the sample IQ single can be selected from a set of delayed samples.

The start and finish of the correlation period is determined by the source of the combined PN sequence, that is by the selected PN block, and corresponds to the start and end of the spreading sequence. The output correlation results are stored in one or more FIFO's (first in first out registers), the particular FIFO used corresponding to the source of the combined PN sequence, that is to the selected PN block.

To maximise use of silicon area the correlator function can be time multiplexed. In this case, for each time slice the hardware is configured by the controlling processor to provide the required multiplicity of functions.

Each of the one or more combiner modules reads the output data from a set of FIFOs and then creates a set of complex numbers comprising the complex correlation results before multiplying each result with a complex weighting factor and then summing the results. The set of complex weighting factors is supplied by the control processor. The combiner module can be implemented by a software task on a digital signal processor, such as the controlling processor or by a hardware module.

The discriminator allocation and configuration module is responsible for implementing the rake receiver algorithm and for allocating the available resources, that is the scramble code generators, PN blocks, correlators and combiner modules. The allocation of resources may be determined by a set of cost functions, such as power consumption, MIPS rate and the like, configuration restrictions, and target performance requirements such as Bit Error Rates (BER). In this way the available resources may be allocated optimally according to a given set of requirements.

Relative timing adjustments between the combined PN sequence and the sample IQ signal are achieved, in embodiments of the invention, by selecting from a set of delayed IQ samples, which allows fine changes to the timing, and/or by selecting from a set of PN samples which allows for larger step changes to the timing. Larger still timing changes and the ability to track continuous changes in phase (that is, a frequency error) are supported by ability to make a dynamic change in timing at the PN scramble code generator.

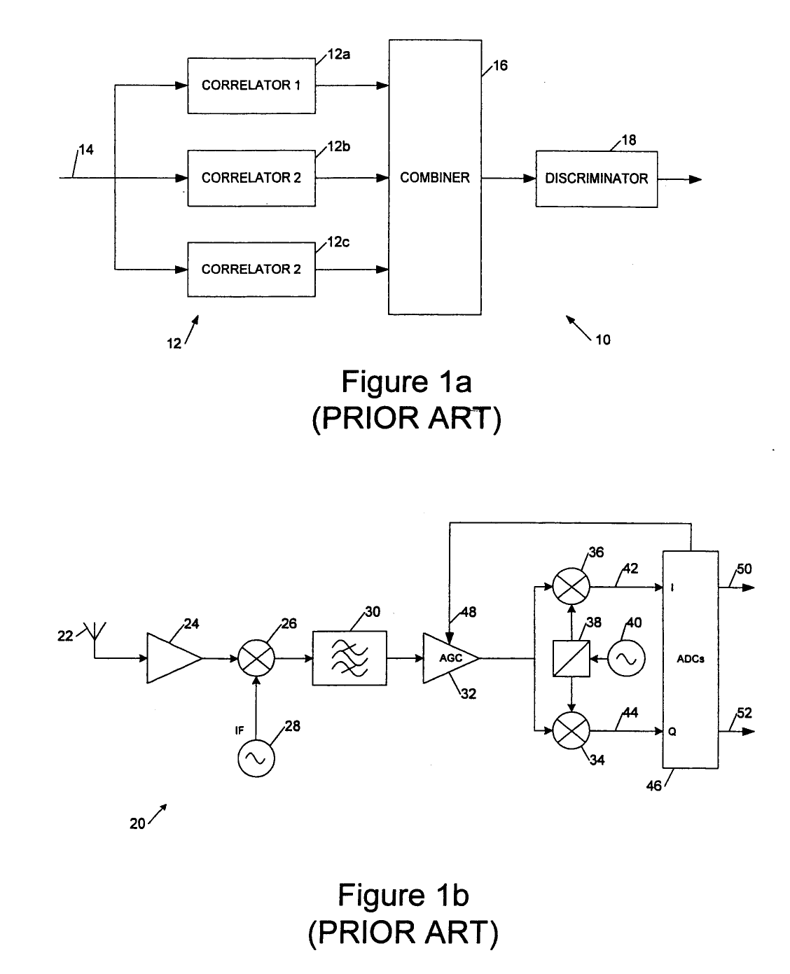

FIG. 1b shows a conventional front end 20 for a spread spectrum receiver such as the rake receiver of FIG. 1a. A receiver antenna 22 is connected to an input amplifier 24 which has a second input from an IF oscillator 28 to mix the input of rf signal down to IF. The output of mixer 26 is fed to an IF band pass filter 30 and thence to an AGC (Automatic Gain Control) stage 32. The output of AGC stage 32 provides an input to two mixers 34, 36 to be mixed with quadrature signals from an oscillator 40 and a splitter 38. This generates quadrature I and Q signals which are digitised by analogue to digital converters 46, which also output a control signal on line 48 to control AGC stage 32 to optimise signal quantisation. Digitised I and Q signals, 50, 52 are thus made available for further processing.

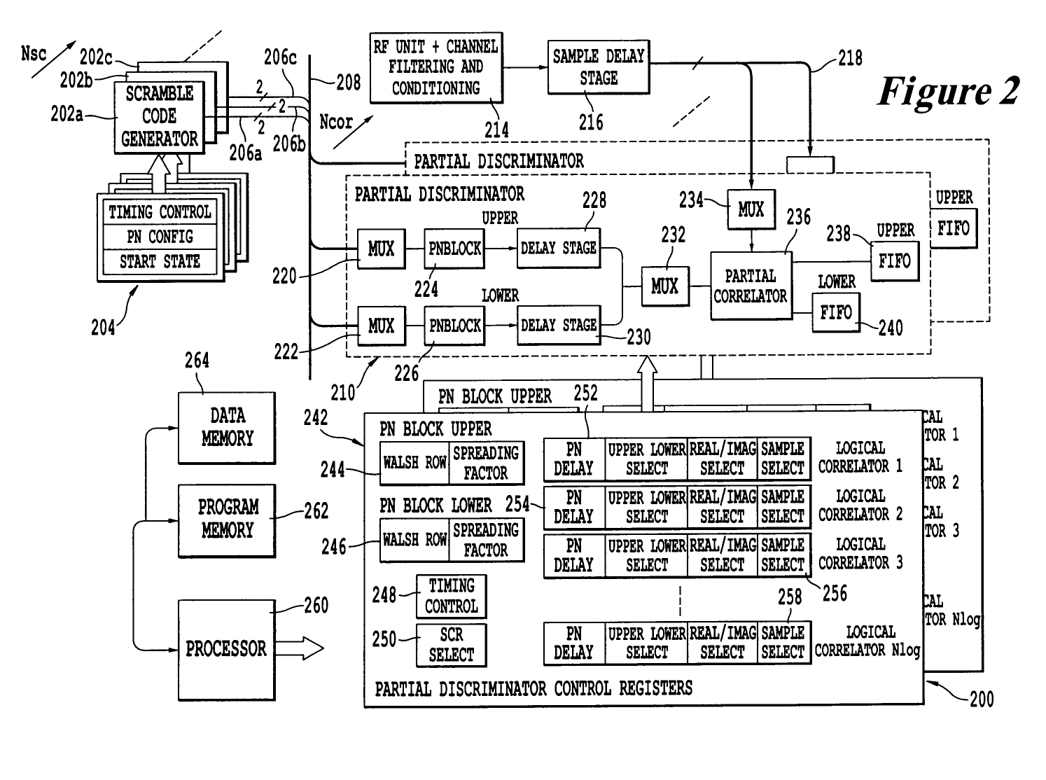

Referring now to FIG. 2, this shows a hardware block diagram of a rake receiver processing system 200 according to an embodiment of the invention. The design of this rake receiver segments the functionality into a set of modules with clear, well-defined interfaces. This allows the implementation to be largely independent of the target system, that is each module may be implemented in hardware or software as required. In one embodiment of the system the scramble code generator, PN block, and correlator are implemented in hardware whilst the combiner and discriminator allocation and configuration modules are implemented in software. The number of scramble code generators (Nsc) and discriminator modules (Ncor) are selected dependent upon the worst case scenario envisaged for the product, that is based upon the maximum number of required data channels, required antenna diversity, the required base station diversity, and the like.

The processing system 200 comprises a plurality of scramble code generators 202a, b, c each of which generates a complex binary PN sequence output on respective buses 206a, b, c. The sequence repeats at a specified time, measured in chips, relative to a reference clock. Each scramble code generator has an associated set of control registers 204. These include a timing control register to specify the PN sequence repeat or restart time, a PN configuration register to specify the PN sequence produced, and a start state register to specify the point in the PN sequence at which the scramble code generator starts or restarts. When the PN sequence is restarted the module generates a frame sync pulse for use by other parts of the rake receiver processing system.

A control processor 260 is provided to set up and control the receiver processing system 200, to configure the processing system architecture and to set up and/or dynamically control the processing modules according to the receiver requirements. Processor 260 is coupled to programme memory 262 which stores data and programme code for initialising and controlling one or more receiver configurations, and to data memory 264 for temporary data storage. Programme memory 262 may comprise, for example, FLASH RAM and data memory 264 may comprise conventional low power static RAM.

The control processor 260 is able to control the scramble code generators 202, in particular to adjust the time at which a PN sequence restarts dynamically. This allows the rake receiver to track a moving path by adjusting timing of the PN sequence. This reduces the complexity of the hardware as compared to conventional systems which either use large delay memories or change the clock speed driving the PN generator.

The receiver front end is illustrated in FIG. 2 by rf unit and channel filtering and conditioning block 214. Any conventional spread spectrum receiver front end, such as that illustrated in FIG. 1b, may be employed. The output of rf block 214, which comprises sampled (i.e. digitised) IQ signals, is passed to a sample delay stage 216 having a plurality of taps, outputs from which together form a delayed sample bus 218. The output 206 of the scramble code generators together comprise a scramble code bus 208 and both the scramble code bus 208 and the delayed sample bus 218 are fed to a plurality of correlators or partial discriminators 210.

A correlator or partial discriminator 210 comprises, in the illustrated embodiment, upper and lower PN block lines and a partial correlator module 236. However in other embodiments more or fewer PN block lines may be provided. Each PN block line comprises a multiplexer 220, 222 coupled to an input of a PN block 224, 226, an output of which drives a delay stage 228, 230. The multiplexer 220, 222 selects one of the (complex) scramble code generator outputs for combining with a spreading sequence generated by the PN block to which it is connected. In a similar way to sample delay stage 216, the delay stage 228, 230 provides a plurality of delayed PN block output taps which can be selected to provide an adjustable PN block output delay. Multiplexer 232 selects the signal from either the upper or the lower PN block line for one input to partial correlator module 236. The other input to partial correlator module 236 is from multiplexer 234 which selects one of the delayed sample signals. In this way time changes in the sample signal timing can be made by multiplexer 234 and delay stage 216 whilst larger changes in the PN sequence time can be made using delay stages 228, 230. Preferably correlator module 236 provides outputs to two FIFO units, FIFOs 238 and 240, which can be used to accumulate correlation results associated with the upper and lower PN block lines respectively.

Referring now in more detail to PN blocks 224, 226, each of these blocks contains the logic to generate a spreading sequence and to combine this with a PN (scramble code) sequence as required by one or more of the relevant standards for specifications such as the 3GPP(2) specification. The input to a PN block is from the set of scramble code generators, from which the PN block can select any generator for combining with the spreading sequence. Preferably at least some of the PN blocks support the CDMA2000 mobile phone standard and thus contain the functionality to implement QOF_{sign} and Walsh_{ROT} features unique to this system.

The correlator or partial discriminator 210 is configured and controlled by a group of registers 242. A set of registers 244, 246, 248 and 250 configures the upper and lower PN block lines. Registers 244 configure upper PN block 224 and registers 246 configure lower PN block 226. In the illustrated embodiment registers 248 and 250 are common to both the upper and lower PN block lines. Registers 244, 246 comprise a Walsh row register to select a Walsh matrix row for use in generating the spreading sequence, and a spreading factor register. Register 250 selects a scramble code generator for the PN blocks. Register 248 is a timing control register which is used to control the timing of the spreading sequence in a corresponding manner to that in which the timing control register of registers 204 controls the timing of scramble code generators 202.

Further sets of registers 252, 254, 256 and 258 are provided to configure the physical correlator 210 to provide separate logical correlators. In the illustrated embodiment registers are provided to allow four different logical correlators to be configured but in principle any number of logical correlators can be provided. Each set of registers 252, 254, 256, 258 comprises a PN delay register to set the combined PN sequence delay imposed by delay stage 228, 230, an upper/lower line select register to control multiplexer 232 to select either the upper or lower PN block line, a real/imaginary select register to control the partial correlator module 236 to calculate either a real or imaginary correlation result, as described in more detail below, and a sample select register, to control multiplexer 234 to select a delayed sampled input signal from delayed sample bus 218. The logical correlator configurations determined by registers 252, 254, 256 and 258 can either be selected under processor control or cyclically in a time-multiplexed mode.

In this described embodiment two or more PN blocks are associated with a single physical correlator and each PN block can be configured for a different spreading code and spreading factor. The correlator 210 uses a symbol sync output provided by each PN block to determine when the output of correlator module 236 is to be sampled, and the sampled value passed on to the FIFO 238, 240 associated with the PN block. In this way a single physical correlator module can support multiple physical channels at different symbol rates.

The output of each PN block 224, 226 is a combined PN sequence as described above. This is a complex sequence as although the spreading sequence is real the scramble code PN sequence is complex. The IQ samples are also complex and thus the correlator 210 must perform a correlation calculation on two sets of complex values. As described above, each physical correlator can implement a number of logical correlators by time multiplexing the summation stage, that is partial correlator module 236, for example over a single chip period. The controlling processor 260 can uniquely configure each logical correlator. This permits a simplified calculation of a complex cross-correlation result.

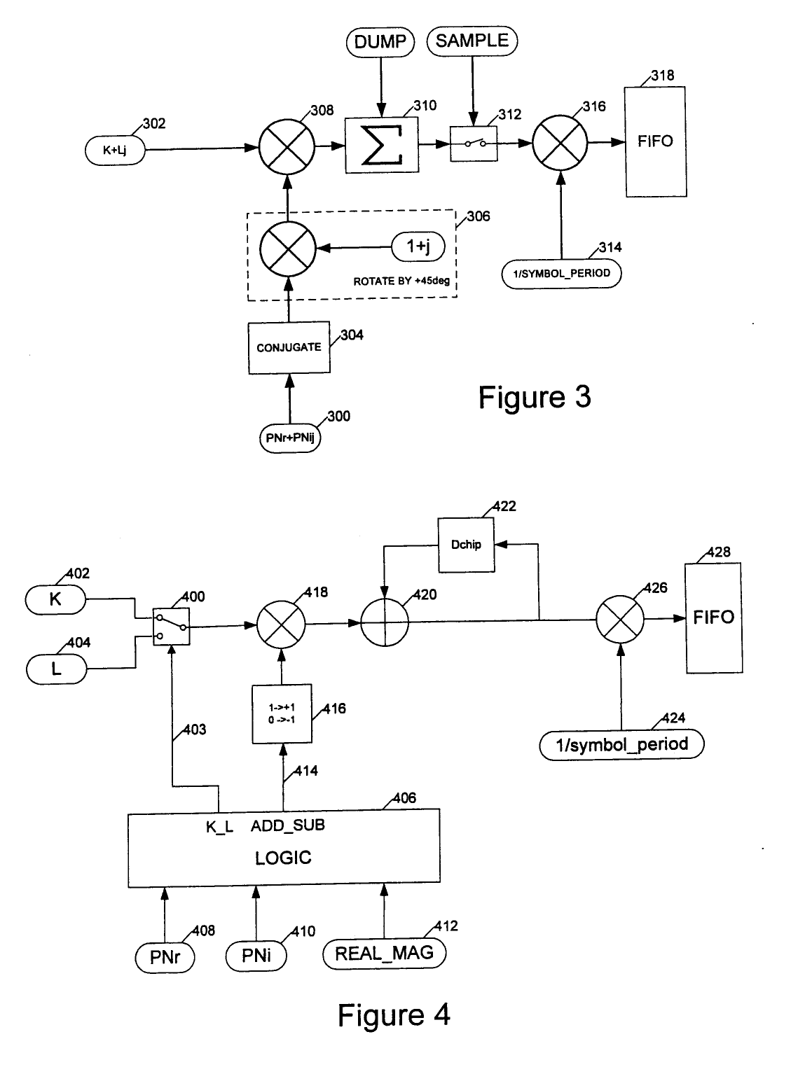

Referring to FIG. 3, this shows functional elements of a complex cross-correlator. These functional elements may be physically implemented in hardware as shown in FIG. 4. In FIG. 3 the complex combined PN sequence is represented by (PNᵣ+PNᵢj) 300 where r denotes a real component of the signal, i denotes an imaginary component of the signal and j represents the square root of −1. Similarly an IQ sample value is denoted by (K+Lj) 302. When these two complex values are multiplied the real component is PNᵣ·K−PNᵢ·L and the imaginary component is PNᵣ·L+PNᵢ·K. This calculation requires at least four multiple operations and must be performed at the sample rate of the IQ signal, which is costly. The complexity of the calculation can be reduced, however, to one addition or subtraction per IQ sample for each component (real and imaginary) by rotating the combined PN sequence by +45°. The effect of this is to transform combined real and imaginary values to purely real and purely imaginary values on which partial correlations may be performed separately. In particular, a +45° degree rotation transforms {1+j, −1+j, −1 −j, 1−j} to {j, −1, −j, +1) hence reducing the multiply to a selection between K or L of the IQ sample and an add or subtract.

In FIG. 3 this operation is performed by conjugating 304 the combined PN sequence, rotating 306 the conjugated combined PN sequence by multiplying the sequence by 1+j, and then multiplying 308 the result with the IQ sample 302 and summing 310 the result. However the multiplication 308 is simplified to either inversion or non-inversion of the IQ sample 302. Summer 310 and switch 312 together comprise an integrate and dump component and the correlator output is sampled at the symbol frequency by symbol clock 314 and multiplier 316, and the output written to FIFO 318.

The result of the correlation must be de-rotated by −45°, but since this is performed on a correlation result this does not introduce a significant time overhead. Advantageously, rather than de-rotate the correlation result the weighting factors used in the combiner can be multiplied by (1−j)/2.

In the embodiment of FIG. 2 each logical correlator can be configured to calculate a real or imaginary correlation result. Thus by using two logical correlators the full complex correlation can be calculated when required. With this flexibility a single correlator can be used when only a single component of the correlation result is required, for example in an early-late tracking scheme. The relative timing between the combined PN sequence and IQ samples can be adjusted for each correlator by selecting the PN sequence delay (in multiples of the chip period) and/or selecting an IQ sample delay (in multiples of the sample period).

FIG. 4 shows one example of a physical hardware implementation of the functional elements of the correlator shown in FIG. 3. In FIG. 4 a switch 400 is used to select either the real (K) 402 or imaginary (L) 404 component of the IQ sample under control of a K_L signal 403 from a logic block 406. Logic 406 has inputs from the real 408 and imaginary 410 components of the combined PN sequence. A further binary REAL_IMAG input 412 is driven by the control processor to set the output of the partial complex correlator to be either the real or imaginary component of the correlation. The values of K_L and ADD_SUB thus differ as a function of REAL_IMAG.

Logic block 406 conjugates and rotates the combined PN sequence input and provides ADD_SUB output 414 to a level shift block 416, which transforms a logic 0 to a −1 voltage level to permit a multiply operation. Multiplier 418 multiplies the output of level shift block 416 by the selected component of the IQ sample 402, 404 and a running sum of the result is maintained by summer 420 and single chip delay 422. The result is then sampled at the symbol period by clock 424 and multiplier 426 and the result written to FIFO 428.

The foregoing rake receiver architecture can be used to meet a range of system performance requirements and can be employed, for example, in a mobile phone handset. In this example the rake receiver architecture can be used to cater for operational extremes such as operation in an office environment, when very high data rates are often possible, and operation on a motorway, when severe multipath fading tends to result in low data rates. Thus in an office environment the rf channel will generally be quasi-static and will usually have a single prominent path whereas when operating in a car on a motorway the rf channel will not be stationary and will normally have multiple paths that will rapidly disappear and reappear as the terminal moves.

One way of achieving a high data rate in a WCDMA system is to make use of a plurality of lower data rate channels, each of these lower data rate channels having a different respective combined PN sequence, therefore requiring a corresponding plurality of correlators. Thus, for example, a 2 Mbps data channel might be provided by concatenating four 500 Kbps data channels. Where the rf channel is quasi-static there is less need for multiple rake fingers and therefore only two fingers may be provided per 500 Kbps data channel, allowing the receiver to resolve two multipath components per channel. The two (rake) fingers in a given data channel can share a scramble code generator but because there is a plurality of data channels (in the example four) a corresponding plurality of scramble code generators will normally be necessary. By contrast where data rates are lower correlators may be allocated to providing further rake fingers rather than additional data channels. In a similar way, data discriminator resources may be reallocated for use in channel tracking and path searching in a severe multipath environment. Logical rather than physical correlators may be allocated to furnish the correlators for these different configurations although the physical configuration of the available elements will generally also need to be taken into account as this may impose additional constraints.

The receiver configuration may be chosen dependent upon a measured or negotiated level or quality of service or it may be selected by, for example a user or network operator. The described architecture reduces the complexity of the modules implemented in hardware and pushes the complexity into software, thus facilitating the support of more advanced receiver algorithms. This is particularly relevant to algorithms which can automatically adapt the whole rake configuration so that the receiver's performance can be optimised for a range of channel environments such as a stationary handset, a fast moving handset, a low C/I, a high C/I and the like.

As well reducing the overall hardware complexity, and hence cost, the design allows a reduction in current consumption. Furthermore, the combination of the described modules and flexible architecture allows a software-defined rake receiver in which the configuration and interconnection of the various elements can be defined either at development time or by the operator when the terminal is in the market, to adapt the receiver for different network configurations.

The components and architecture described herein can be used in both terminals and base stations and can support multiple standards, including WCDMA and CDMA2000. No doubt many other effective alternatives will occur to the skilled person and it will be understood that the invention is not limited to the described embodiments but encompasses modifications apparent to those skilled in the art lying within the spirit and scope of the claims appended hereto.

We claim:

1. A method of adjusting the relative timing of a spreading sequence card and a sampled input signal for a spread spectrum receiver correlator, the spreading sequence having an associated spreading sequence chip clock, the input signal being sampled at sample clock intervals, the method comprising:
delaying the sampled input signal by an integral number of sample clock intervals to provide a fine relative timing adjustment; and
delaying the spreading sequence by an integral number of spreading sequence chip clock periods to provide a coarse relative timing adjustment.

2. A method of adjusting relative tinning as claimed in claim 1 wherein the spreading sequence comprises a combination of a first pseudorandom-sequence and a second, longer pseudorandom sequence, the method additionally comprising restarting the second pseudorandom sequence to further adjust said relative timing.

3. A method of adjusting the relative timing of a spreading sequence and a sampled input signal for a spread spectrum receiver correlator, wherein the spreading sequence comprises a combination of a first pseudorandom sequence and a second pseudorandom sequence equal to or longer than the first sequence, the method comprising adjusting said relative timing by restarting the second pseudorandom sequence.
